(19) United States
(12) Patent Application Publication
(10) Pub. No.: US 2011/0161016 A1
(43) Pub. Date: Jun. 30, 2011

(54) System for Analyzing A Fluctuating Flow of A Mixture of Gases

(75) Inventors: Henk Van Middendorp, Achterveld (NL); Johannes Martinus Esse Van Den Burg, Houten (NL); Adrianus Lambertus Johannes Maria Nikkelen, Wijk bij Duurstede (NL); Gerrit Van Den Brink, Bennekom (NL)

(73) Assignee: Relitech B.V., Nijkerk (NL)

(21) Appl. No.: 12/997,134

(22) PCT Filed: Jun. 10, 2009
(86) PCT No.: PCT/NL2009/050323

§ 371 Date: Mar. 16, 2011

(30) Foreign Application Priority Data
Jun. 10, 2008 (NL) 2001665

(51) Int. Cl. G01F 5/00; G06F 19/00

(52) U.S. Cl. 702/45

(57) ABSTRACT

The invention relates to a system and method for analyzing a fluctuating flow of a mixture of gases having an optionally variable frequency. The system can be used to determine momentary presence and quantity of at least one selected gaseous component in the fluctuating flow. The system uses at least one electronic sensor adapted to generate a measurement signal representative of at least one of the presence and quantity of the at least one gaseous component. The at least one electronic sensor has a response rate slower than the frequency of the fluctuating flow and the measurement signal is subjected to a correction to construct a momentary corrected signal that equals, or at least closely resembles, at least one of the momentary presence and quantity of the at least one gaseous component. In particular the correction includes a compilation of inverse filtering and moving average filtering.

The invention relates to a system for analyzing a fluctuating flow of a mixture of gases having an optionally variable or non-varying frequency. It is often necessary to analyze such gas flows dynamically to determine a momentary presence and/or quantity of certain gaseous components in the fluctuating flow. Usually such determinations are carried out using one or more electronic sensors that are adapted to generate a measurement signal representative of the presence and/or quantity of the relevant gaseous component.

Depending on a particular gaseous component to be detected or measured an electronic sensor suitable for detecting or measuring that particular gaseous component may have a response rate that is substantially slower than the frequency of the fluctuating flow. Conversely there may be a choice of sensors with faster and slower response rates, but those with a response rate that is higher than, e.g. at least twice, the fluctuating frequency may not be economically feasible for a particular application. In particular, some aspects of metabolic measurement require accurate determination of the flow and gas fractions and traces of the inhaled and exhaled gases. First, the influences of the sample system need to be eliminated and secondly, the flow and fraction signals need to be synchronized in time. Hence there is a general need to improve the accuracy of measurements obtained with electronic sensors in analyzing a fluctuating flow of a mixture of gases.

A known system and method for monitoring breath as disclosed in published patent application US 2008/0119753 corrects the composition of a signal obtained and improves response time in accordance with a protocol. This known system and method accelerates the measured fractions by performing the following steps:

a) providing “K” representing a factor depending on slope and flow volume;
b) new=value+slope*K;
c) Time shift depending on slope (=first derivative) and second derivative;
d) 2nd correction: new=value+slope*(K/2);
e) 3rd correction: new=value+slope*(K/(2̂N));
f) Arranging into phase of the signals relating to O₂, CO₂ (N₂O) based on the correlation between the signals; and
g) Arranging into phase of the flow signal (based on pulsatile effects).

Accordingly it is an object of the present invention to overcome or ameliorate at least one of the disadvantages of the prior art. It is also an object of the present invention to provide alternative structures which are less cumbersome in assembly and operation and which moreover can be made relatively inexpensively. Alternatively it is an object of the invention to at least provide the public with a useful choice.

To this end the invention provides for a system and method for analyzing a fluctuating flow of a mixture of gases having an optionally variable frequency. The system can be used to determine momentary presence and quantity of at least one selected gaseous component in the fluctuating flow. The system uses at least one electronic sensor adapted to generate a measurement signal representative of at least one of the presence and quantity of the at least one gaseous component. The at least one electronic sensor has a response rate slower than the frequency of the fluctuating flow and the measurement signal is subjected to a correction to construct a momentary corrected signal that equals, or at least closely resembles, at least one of the momentary presence and quantity of the at least one gaseous component. In particular the correction includes a compilation of inverse filtering and moving average filtering in accordance with a set of rules. Preferably connections in the system are defined linking outputs and inputs of filter blocks in accordance with a connection map, which is generated from an initialization file. Optionally the system may also include a relatively fast inverse filtering stage and a smoothing filtering stage, which incorporates the gain expert filter. In known metabolic measurement devices an empirical method of response correction was used, while the more advanced method now proposed is based on inverse filtering technique. Validation studies show that with the inverse filter technique, the requirements for metabolic measurement can be met. Furthermore, the visualization of the fraction signals can be much improved compared to the method used in existing metabolic measurement devices. A further advantage of the inventive system for analyzing fluctuating gas flows is its enabling of analyzing gas traces with accuracy not available before.

More in particular, and in contrast to the prior art of US 2008/0119753, the present invention functions by simultaneously converting a gas fraction by an inverse filter and a moving average filter, and in that both results are then combined by an expert filter to create the real fraction on basis of the derivative of both signals. Significant differences include:

(i) Inverse filter is based on the actual measured physical properties of the sensor;
(ii) The filtered result is independent of possibly measured flow;
(iii) The filtered result is independent of other gases possibly measured; and
(iv) The phase difference in the measured flow is corrected by a separate delay measurement.

Further advantageous features of the system of the invention include a relatively fast inverse filtering stage and a smoothing filtering stage. In this regard it is advantageous when the inverse filtering stage precedes the smoothing filtering stage. In connection with such a layout the smoothing stage may be provided with a branch for correction filtering and a branch for moving average filtering. It is also advantageous when the smoothing stage further includes a gain expert filter block, joining the branches for correction filtering and moving average filtering into a common output. In this way the gain expert filter block mixes the correction signal and the moving average signal in accordance with predefined rules.

Another preferred embodiment of the invention has its gain expert filter block controlled by a derivative of the correction signal and a derivative of the moving average signal. With such a system rules for the gain expert filter block may use thresholds that are applied at signals with amplitude normalized to a step size as found in these signals. Preferably the step sizes can then calculated by a step expert subroutine. Also the rules for the gain expert filter block may include comparison of the moving average signal and the correction signal with a first threshold in determining a gain value.

In a preferred arrangement of the system according to the invention, the smoothing stage includes a filter block that is adapted to attenuate ringing frequencies introduced by the inverse filtering. More preferably the filter block adapted to attenuate the ringing frequencies is in the form of a moving average filter. In particular a length of the moving average can be adjusted to frequencies of the ringing which are typical for a specific inverse correction filter. In addition the smoothing stage can further include a delay filter block that has a delay equal to a delay of the moving average filter block. This delay is preferably introduced to obtain exactly the same delay in signal moving average signal path and the correction signal path. Furthermore a first filter block for determining a derivative may be included in this preferred system. In this regard the first filter block for determining a derivative may also be positioned between an output of the moving average filter block and an input of the gain expert filter block to control the gain expert filter block. The derivative of the moving average signal thus can be one of the inputs that control the gain expert filter block. An additional second low pass filter block may also be included between an output of the first filter block for determining a derivative and an input of the gain expert filter block. This low pass filter attenuates higher frequencies in the derivative of the moving average signal to prevent signal noise in this frequency band from disturbing the gain expert.

According to another aspect of the invention, the system may further include a second filter block for determining a derivative for providing a derivative of the correction signal as an input for controlling the gain expert filter block. In combination with this feature the system may also further include a third low pass filter block between an output of the second filter block for determining a derivative and an input of the gain expert filter block. This filter then attenuates higher frequencies in the derivative of the correction signal to prevent signal noise in this frequency band will disturb the gain expert filter block.

Advantageously a second delay filter block may be included between an output of the moving average filter block and an input of the gain expert filter block, to compensate for signal delay of the first filter block for determining a derivative and the second low pass filter block. This delay can be introduced to obtain an equal delay in the different moving average signal paths. Again a third delay filter block may advantageously be included, between an output of the first delay filter block and an input of the gain expert filter block, to compensate for delay of the second filter block for determining a derivative and the third low pass filter block. This delay can be introduced to obtain also an equal delay in the different correction signal paths.

It is further preferred for the system to further include an input step expert filter for analyzing the input signal to determine a step size and onset times of the input signal. These values are desirable for determining the delay time and for the gain expert filter block. In combination with this feature the system may further include an inverse response correction filter block, which advantageously may be a finite impulse response filter. This helps to guarantee stability and to obtain DC accuracy.

In general it may be further preferred for the system to include an output step expert filter block to analyze an output signal to determine onset times of the output signal. This is preferred to qualify the filter behavior. Also it may be further preferred when in the system connections are defined linking outputs and inputs of filter blocks in accordance with a connection map, which is generated from an initialization file.

The above and further aspects of the invention will now be described in reference to the accompanying drawings, in which:

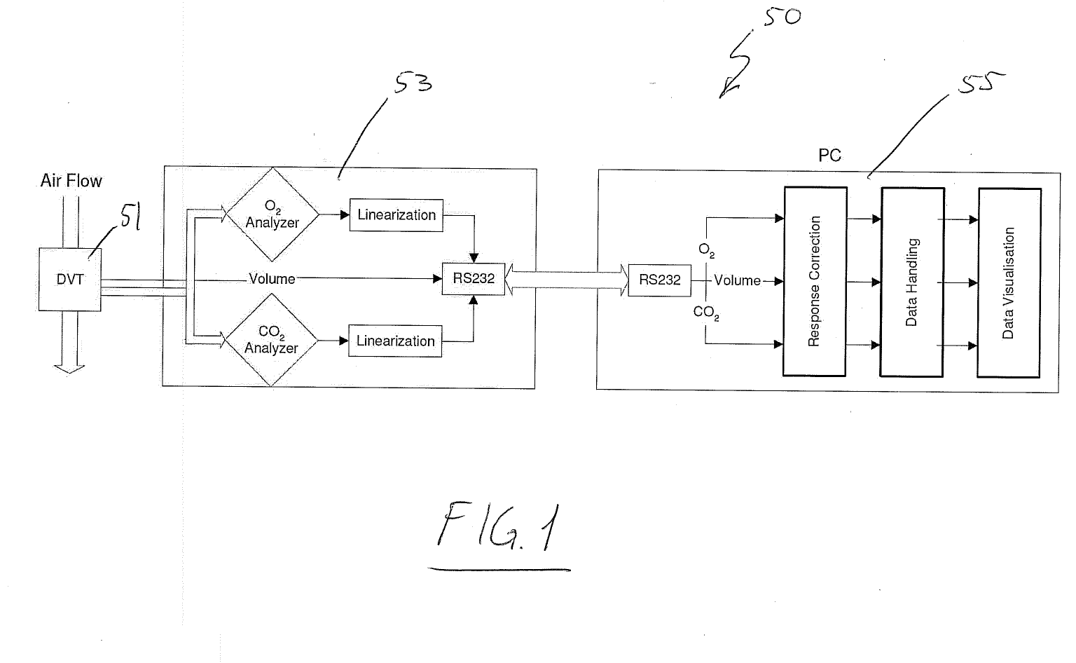

FIG. 1 shows a block diagram schematically illustrating a system with response correction;

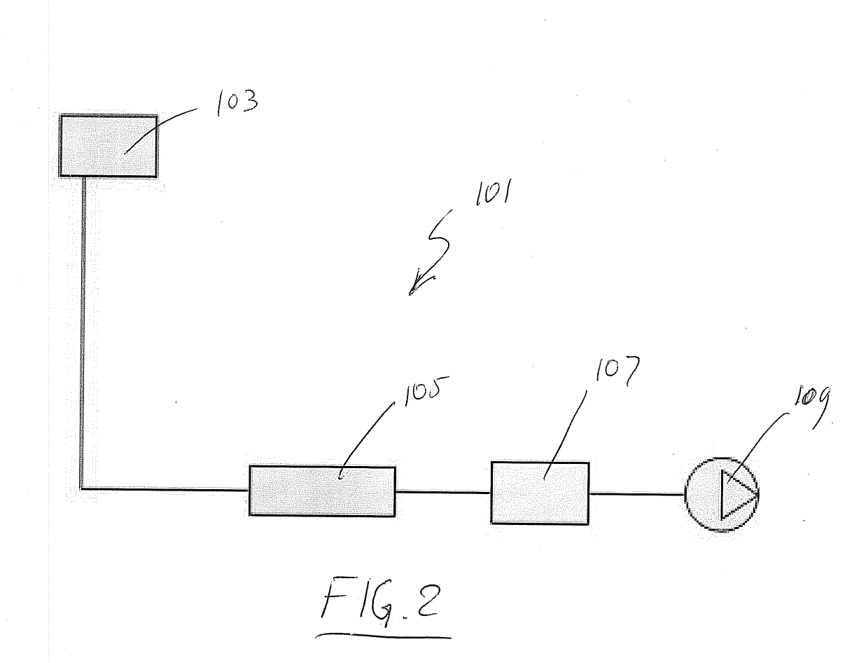

FIG. 2 is a schematic representation of a proportional gas analyzer;

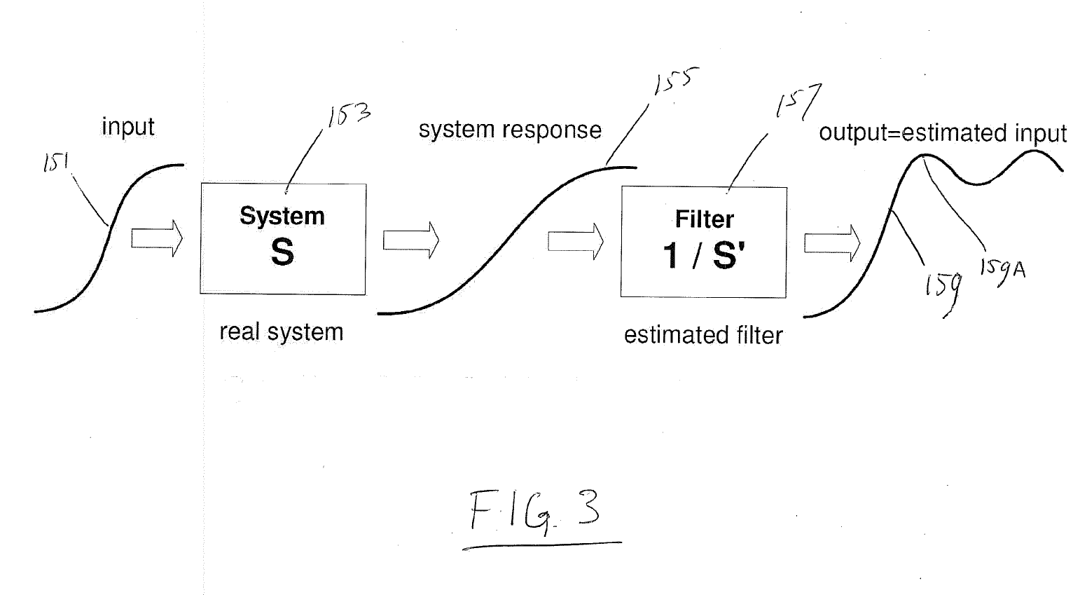

FIG. 3 schematically shows an overshoot that can result from inverse filtering;

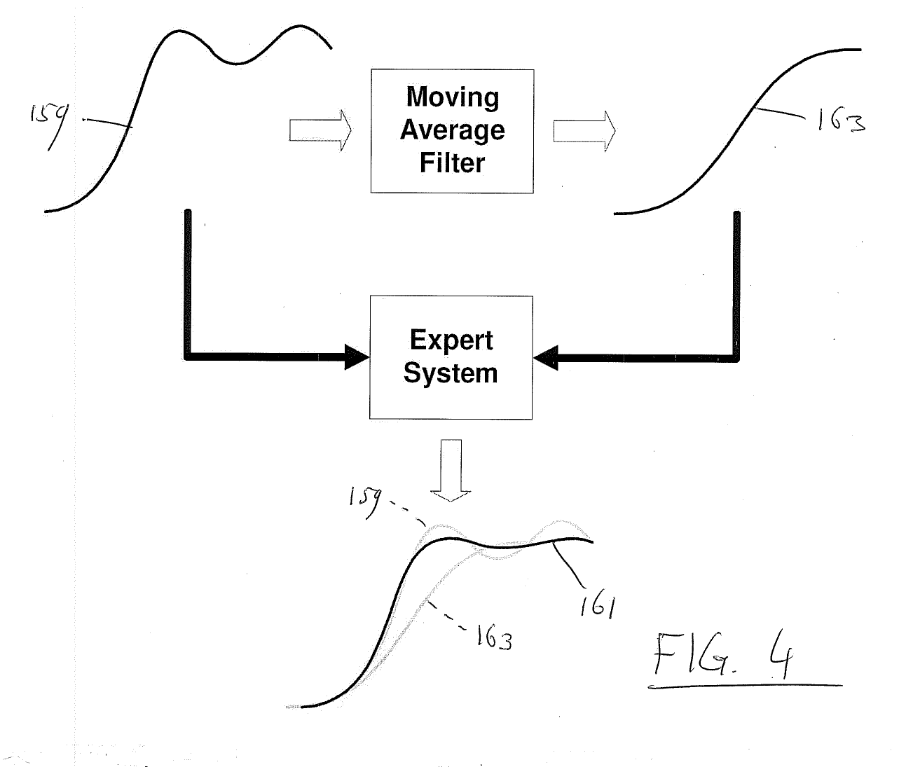

FIG. 4 is a schematic representation of a smoothing principle according to the invention;

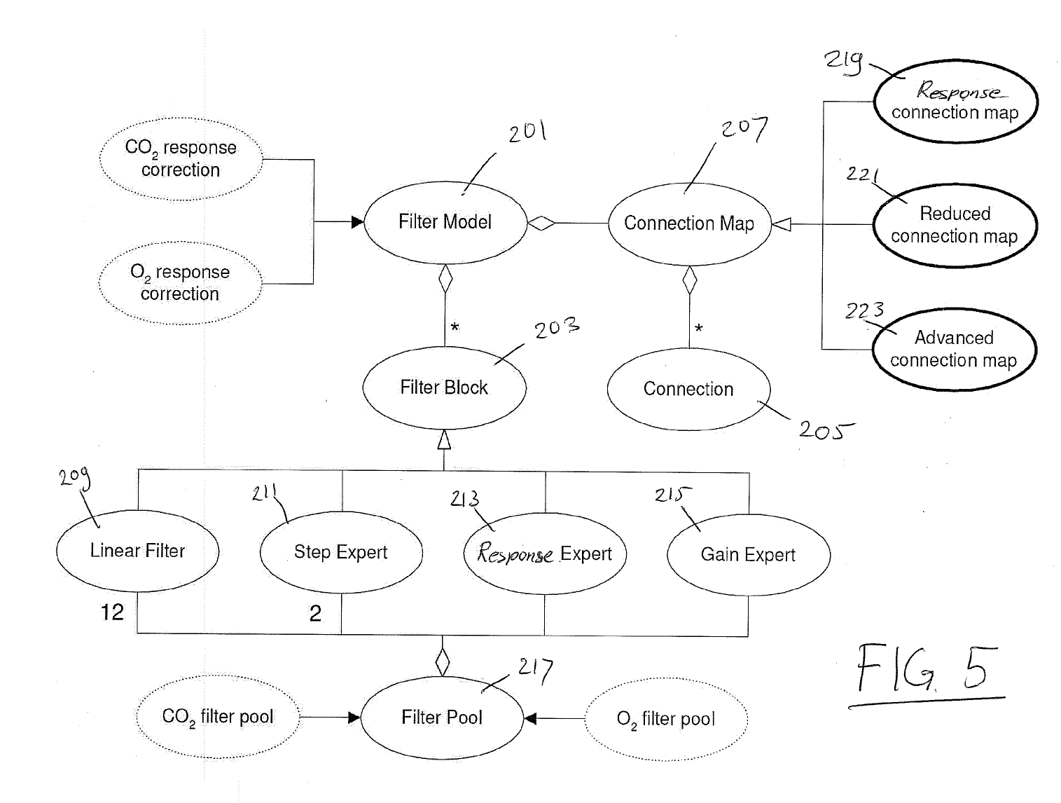

FIG. 5 is a diagram for the response correction software module;

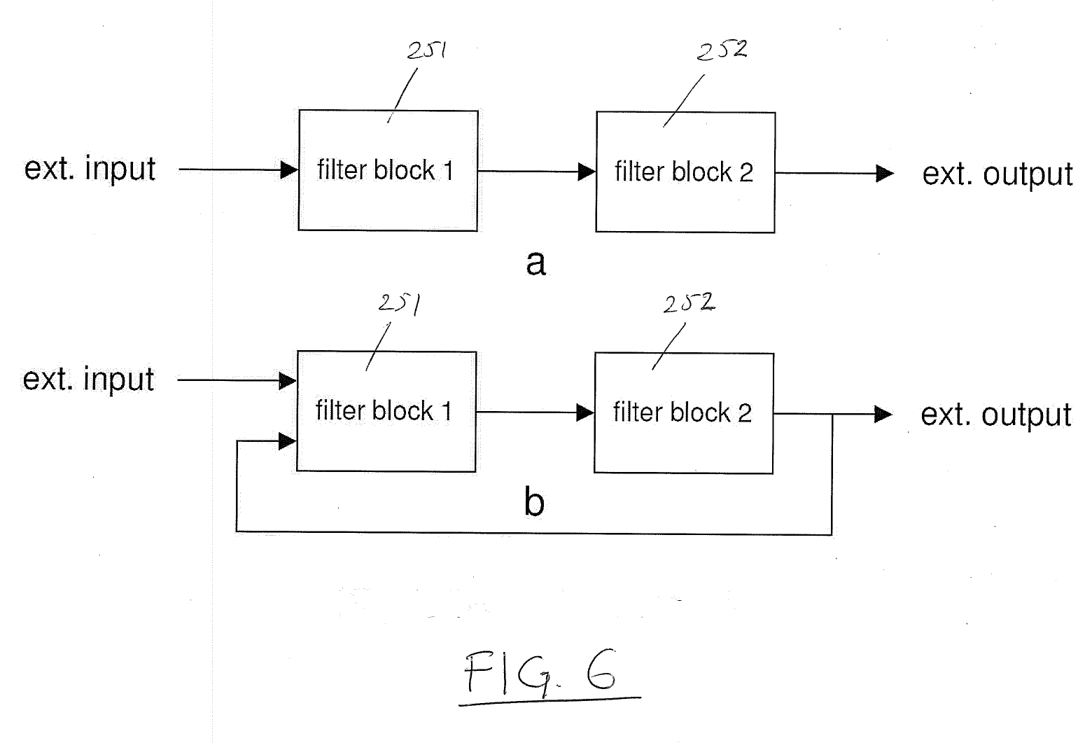

FIGS. 6a and 6b show a simple filter model with two filter blocks;

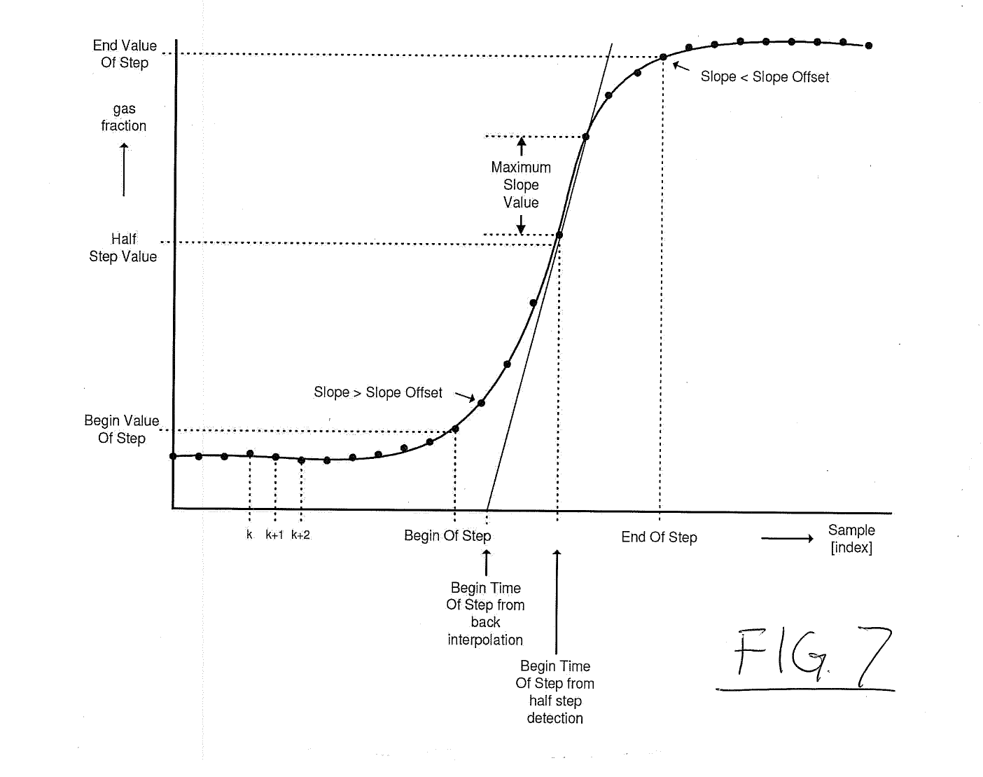

FIG. 7 illustrates decision points for step detection;

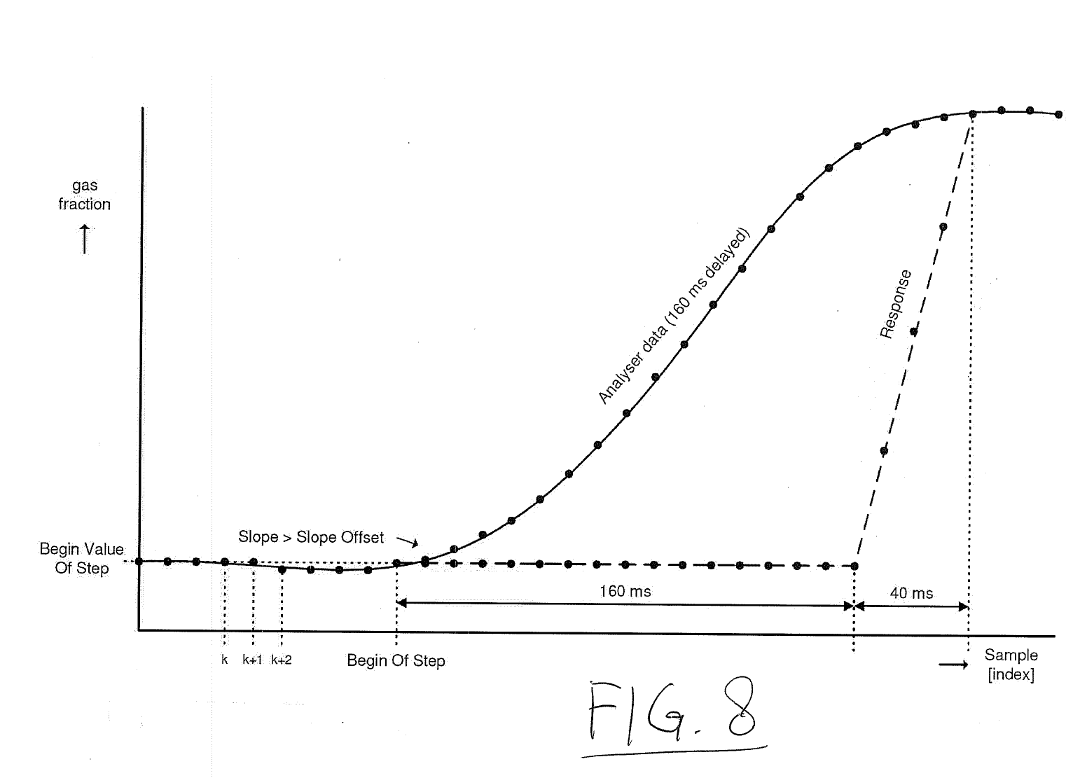

FIG. 8 is a graphical representation of an existing response wizard;

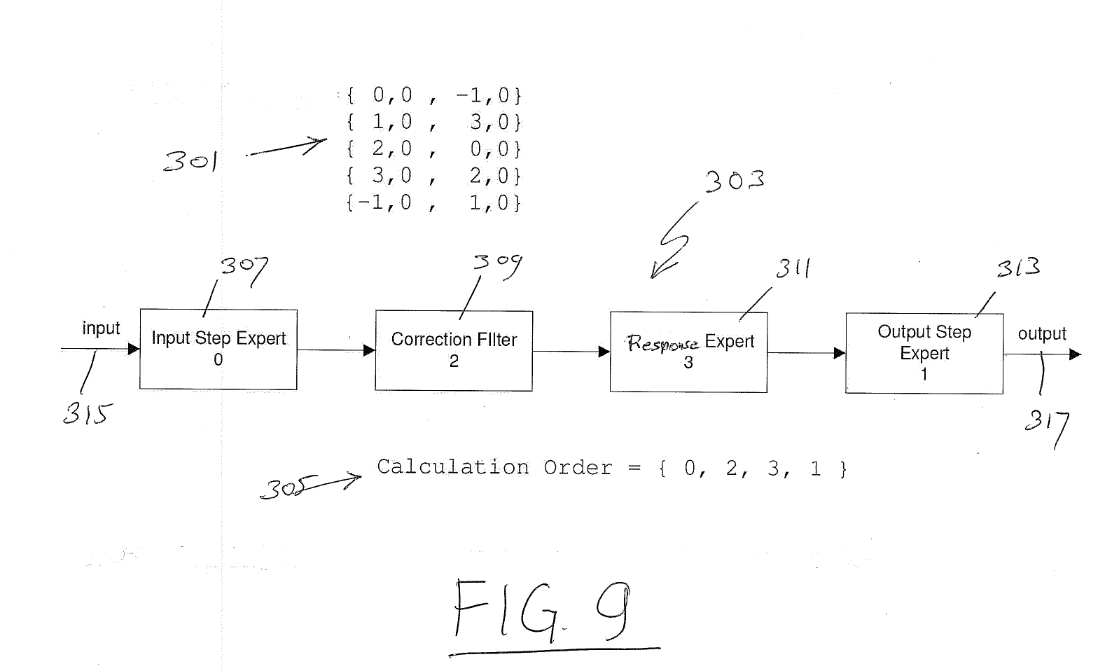

FIG. 9 show a existing response connection map and filter model;

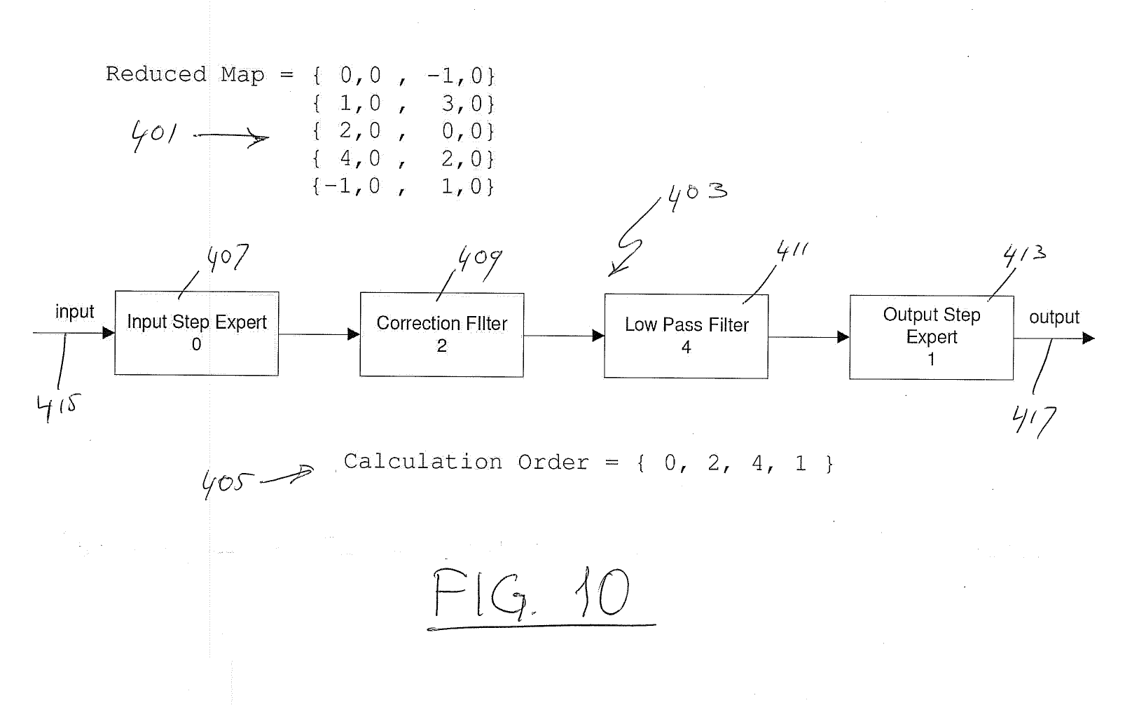

FIG. 10 shows a reduced connection map and filter model;

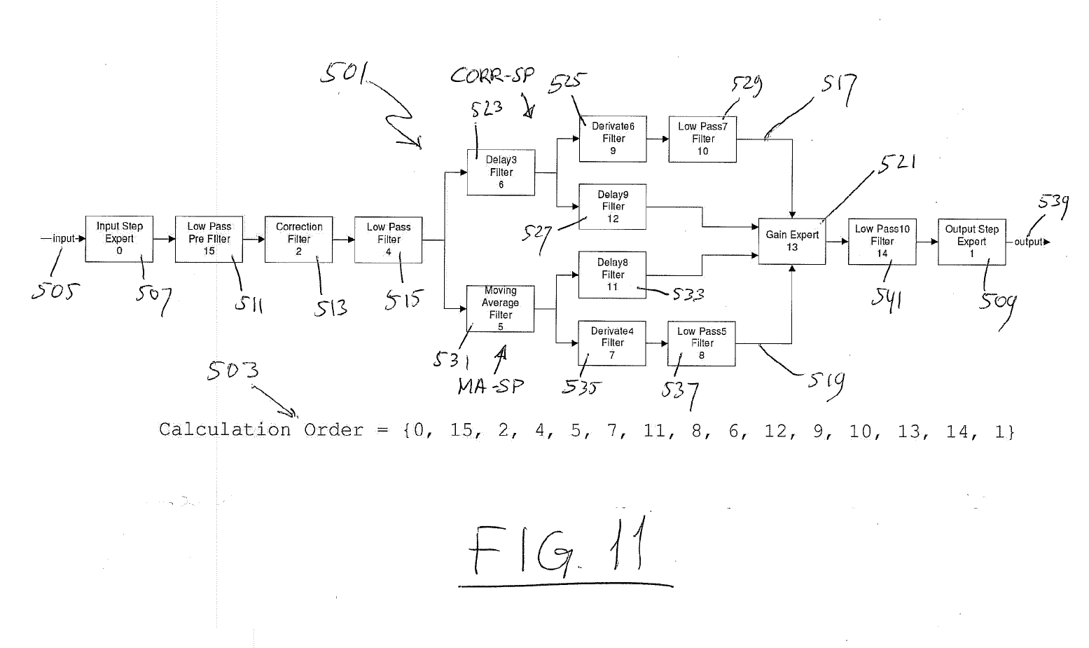

FIG. 11 shows an advanced connection map and filter model; and

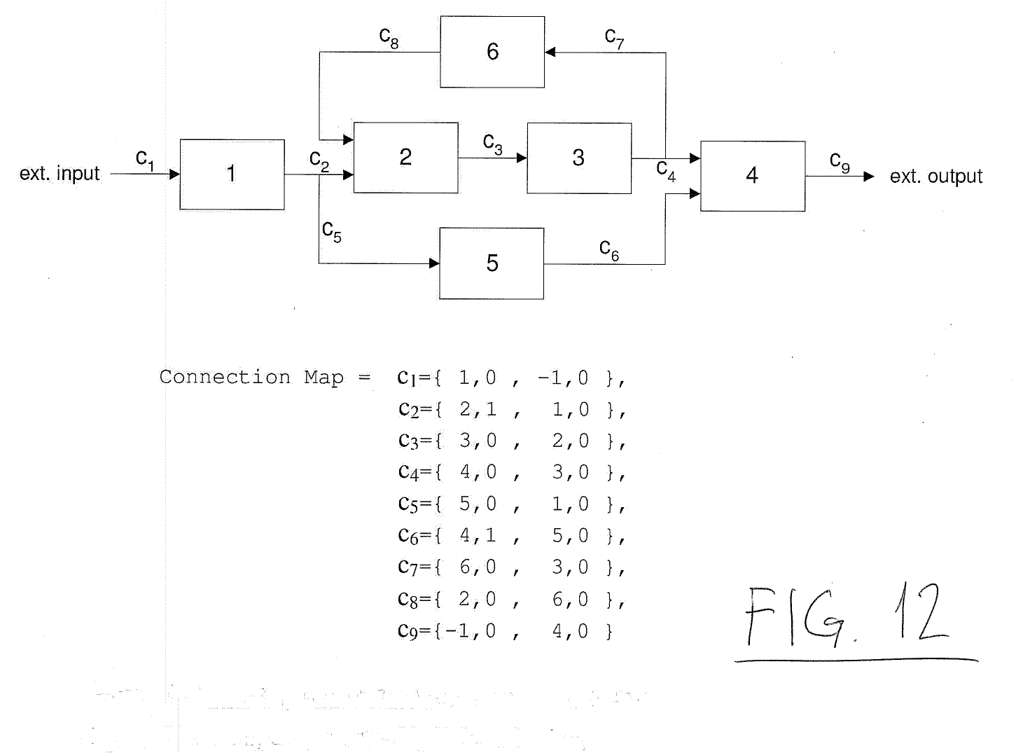

FIG. 12 shows a filter model and connection map for explaining an algorithm for determining a calculation order.

FIG. 1 is a block diagram schematically illustrating a system 50 with response correction. The gas analyzing system 50 includes a flow meter or flow sensor 51, a gas flow analyzing device 53 and a processing unit, such as computer 55. The gas flow analyzing device 53 can be, for example, an metabolic measurement device. To determine the oxygen uptake (V′O₂) and carbon dioxide production (V′CO₂) of a subject the measured flow and fraction signals must be integrated. Due to the tight specifications of metabolic measurements integrating the flow and fraction signals is not straightforward. The fraction signals are significantly influenced by the pneumatic system by which the gas is transported and by the response of the gas analyzers. For these system influences need to be corrected. Furthermore, the flow and fraction signals need to be synchronized in time. Together, the correction of the system influences and synchronizing the flow and fraction signals is called response correction.

In systems for analyzing a fluctuating flow of gaseous mixtures, such as metabolic devices, the flow can be measured with a digital volume transducer (DVT). A suitable flow meter for such purposes, amongst others, is disclosed in EP 0369506. To reduce the effect of noise encountered in other flow sensors a specific volume can be measured over a fixed time interval. The volume is measured by counting the number rotations of a spinning fan. Because of the digital measurement the transducer introduces no significant time delay and does not influence the characteristics of the flow signal. The DVT pulses are conveniently counted in a first register and the DVT pulse times are counted in a second register.

Generally the gas flow from the flow meter is channeled through a sample tube to an input of a gas analyzer. Subsequently, data representative for the gas composition are converted into an electrical signal. Transporting the gas to the analyzers relatively takes a considerable amount of time, introducing a substantial time delay compared to the flow signal. Furthermore, transporting gas trough a tube filters out the fast fluctuations of the gas flow. In addition the characteristics of the analyzer influence the sample results as well. From the perspective of obtaining momentary measurements it is important to correct for these influences.

According to another aspect of the invention the influence of the sampling system may also be eliminated by employing proportional sampling. In a low ventilation part the average sample flow is very low. This leads to a slow response time and a large delay time. At high ventilations the max pump capacity is used leading to a high sample flow, fast response time and short delay time. It was therefore recognized that there could be an advantage when the ratio is depending on the ventilation, rather than being constant. This situation may lead to better performance at lower costs. In proportional sampling the gas sample is extracted by a proportional pump via a relatively small mixing chamber. The proportional pump is controlled directly, or indirectly, by signals from the DVT sensor to adapt the flow through the pump in proportion to the gas flow measured by the DVT sensor. By controlling the maximum flow rate of the proportional pump to obtain an average sample flow that is continuous, the response time of the gas analyzer can be made independent of the flow fluctuation. A proportional gas analyzer 101 is schematically shown in FIG. 2, in which 103 is a flow sensor, such as a DVT sensor. A mixing chamber 105 and a gas analyzer 107 are positioned between the volume sensor and a proportional pump 109. The gas sample is sucked in by the proportional pump 109. This pump 109 is controlled by a signal obtained from the flow sensor 103, so as to obtain a flow through the pump 109 that is proportional to the gas flow being sampled. The range of proportional control is preferably adjustable. The capacity of pump 109 is selected in accordance with the required maximum flow rate of the sample. Preferably the maximum pump flow is controlled to obtain an average sample flow that is substantially identical for low and high frequencies. Thereby the response time of the relatively small mixing chamber 105 will become dynamically independent of the flow frequency. The effect is comparable to a mixing chamber that would have a volume changing with the rate of the flow frequency. The dynamic ranges of the proportional pump 109 and volume sensor 103 are thus selected to be comparable to one another. Also the responsiveness of the pump 109 needs to be high and comparable to that of the volume sensor 103. By application of the relatively small mixing chamber 105 the gas flow will have a composition that is relatively constant and thereby all gas fractions and gas traces will be relatively constant. As a result the responsiveness of gas sensors used in the gas analyzer 107 becomes unimportant and can be slow. Proportional sampling can be employed when response corrective filtering does not provide the desired results. In particular proportional sampling can be used where response of the gas analyzer is extremely slow, such as in excess of 0.5 s (500 milliseconds).

The proposed solution of proportional sampling has solved the following problems:

1. At low ventilation the pump flow is not enough to follow a high peak flow. The sampled volume is too small then, and the concentration will not be proportional to the real value. This requires compensation of the sampling method, in order to reduce the error caused by this ‘clipping’ at high ventilations. By taking a certain margin, the number of clipping's can be reduced.
2. During analyzing, ventilation (flow rate) will change and as a result the ratio R must be adapted. The change of the ratio R will cause temporary differences in averaged concentrations.

The error magnitude should be estimated and can be reduced by limiting the maximal change in ratio R. A desired ratio R was established on basis of the maximum peak flow during 30 s and the average ventilation during the same period. The margin needed to avoid clipping of the pump, (when the desired pump flow is higher than the maximum pump flow) should be relatively large at low ventilation and can be small at high ventilation. The relation between V′e and the ratio R is defined as follows:

R=Rmax·[(V′e−V′e,min)+M·(V′e,max−V′e)·V′e,min/V′e,max]/(V′e,max−V′e,min)

### Wherein:

Rmax=maximum ratio (at PF=12 l/s, or V′e=1801/min) (−)
R=ratio to be used (−)
V′e min=minimum ventilation (l/min)
V′e max=maximum ventilation (l/min)
V′e=measured ventilation (l/min)
M=margin at minimum ventilation (−)

With V′e min=24 l/min, V′e max=180 l/min and M=1.5 this leads to:

R=Rmax·(V′e+15)/195

To make the calculated ratio R more stable, it is recommended to use an averaging method. This method should also limit the change in variation of the ratio R, because this might lead to errors in averaged concentrations. It was established that averaging over 30 seconds is fast enough for adapting to rapid changes in load and ventilation and does not lead to large errors. The momentary error in V′O₂ is reduced to zero within the 30 seconds averaging period. In conclusion the temporary error in V′O₂ is less than 3% when the change in V′e is less than 15 to 30% (V′e level at 180 resp 24 l/min) using an averaging period of 30 s. The limiting factor is that the V′e may not change any faster than 24 l/min per 30 s to make a sufficient adaptation of ratio R possible. It is thus recommended that a margin of 1.5 between expected maximum peak flow and pump capacity is sufficient and will lead only to neglectable errors.

However according to a primary aspect of the invention the flow and gas fraction signals are synchronized in time using corrective filtering. While inversed filtering has been used before, an inverse filter based on the estimated impulse response S′ results in an overall system response that can contain overshoot as illustrated in FIG. 3. In a schematic arrangement FIG. 3 shows an input signal 151, a measuring system 153 for capturing the signal 151 and a response signal 155 as reproduced by the measuring system 153. To reproduce an output signal that is representative of the input signal 151, an inverse correction filter 157 is provided for producing an output signal 159. The output signal 159 has a deformation 159A, called “overshoot”. The invention recognizes that the reason for overshoot to occur lies in the fact that such filter design is merely based on frequency domain analyses instead of time domain analyses. For example, matching the frequency spectrum of the impulse response will introduce a frequency dependent phase shift. Furthermore, realizing the filters digitally results in a discrete frequency spectrum instead of a continuous spectrum. These aspects influence the shape of the filter response in the time domain. For the response correction filter it is important to recover the shape of the original input sample by minimizing these site effects. A number of standard techniques are available to minimize the overshoot. Minimizing or eliminating the overshoot, however, often affects the rise time and/or the delay time of the signal. For the present application the rise time may not be affected and the overall delay time must be limited. Therefore, a smoothing technique has been developed to minimize the overshoot without disturbing the rise time and the delay time of the signal. The resulting smoothing algorithm will now in principle be explained in the next section.

FIG. 4 shows in principle the smoothing technique. The output signal 159 of FIG. 3 is subjected to an additional filtering to arrive at a corrected signal 161 that equals, or at least resembles, the original input signal (151 in FIG. 3). The corrected signal 161 represents an improvement over the correction (represented as 163) obtainable by the mere application of moving average filtering. The corrected system response (signal 159) can contain overshoot (159A) known as ringing, which is mainly caused by the inverse filtering technique used to enhance the response time of the gas signals. Because of the consistency of the ringing frequencies, they can be suppressed by applying a moving average filter to the filtered responses. However, applying a moving average filter will again decrease the rise time of the signals. The principle of the present smoothing technique is to combine the “best” parts of the “fast” inverse filtered response and the “smooth” moving averaged response (FIG. 4). The technique we use to implement the smoothing algorithm is based on an expert system. A gain expert system blends the inverse filtered response and the moving averaged response by applying a set of rules. The curve shown in full in FIG. 4 represents the resulting output signal.

The design of the smoothing filtering includes tuning of the smoothing filter and pre-filtering. The mean ringing frequencies in the case of the corrected O₂ and CO₂ responses can be 7.7 Hz and 11.1 Hz respectively. The length of the moving average filter must match the ringing period of the O₂ and CO₂ responses, 130 ms and 90 ms respectively. Combining the “best” parts of the “fast” inverse filtered response and the “smooth” moving averaged response is done by comparing the first derivatives of the inverse filtered response and the moving average response. The rules for the gain expert are based on the properties of the first derivative of the inverse filtered response and the first derivative of the moving average response. The values for the thresholds are determined by trial and error and are specified for a normalized step. This means that in practice these values need to be multiplied by the actual step value. As regards pre-filtering, the O₂ and CO₂ pre-filters are Hamming filters. This means the coefficients of the filters are determined using a Hamming window which results in a FIR filter with a linear phase characteristic. The −3 dB frequency is at 19 Hz and the gain factor of the filter at the critical point of the spectrum (5 Hz) is 0.98.

Software implementation is accomplished by designing the software module for the response correction to be a flexible filter model with independent response filters for O2 and CO2. Each response filter is modeled as a collection of filter blocks with a specific functionality (e.g. FIR or IIR filter). By connecting the different filter blocks according to a specific connection map the overall response filter is constructed.

A class diagram for the response correction software module is illustrated in FIG. 5. Classes are depicted with continuous lines and class instances (=object) with dotted lines. The bold lines indicate static classes. An overview of classes includes a filter model 201, a filter block 203, a connection 205, a connection map 207, a linear filter 209, a step expert 211, a existing response wizard 213, a gain expert 215, a filter pool 217, a existing response connection map 219, a reduced map 221, and an advanced map 223.

The filter model 201 may comprise a plurality of filter blocks as will be explained in more detail herein after. The filter blocks have a calculation priority that is determined from the structure of the filter model. The structure of the filter model is defined by the connections between the different filter blocks. A connection is defined as a link between input and output of two filter blocks. A filter model has exactly one external input and one external output. The external input is used to import data into the filter model and the external output is used to export data from the filter model. The metabolic measurement device has one filter model for the O2 response correction and one for the CO2 response correction. The two models are identical in structure, which means that they may comprise identical filter blocks and have the same input/output connections.

Each filter block 203 has a unique identification within a filter model. A filter block implements a particular functionality, which for the metabolic measurement device can be of one of the following types: Linear Filter, Step Expert, Response Expert, and Gain Expert. Every filter block has a fixed number of inputs and outputs. For the metabolic measurement device only the linear filter blocks can be initialized from file.

The connection 205 is defined as a link between exactly two filter blocks. Connections can also be used to map the external input and output to the appropriate filter block. The identifiers for an external input and output are defined as −1. For optimization purposes inputs and outputs are numbered starting at 0. FIGS. 6a and 6b show a simple filter model consisting of two filter blocks 251, 252. Upper FIG. 6a shows the open loop connection of the two filter blocks and lower FIG. 6b shows the closed loop equivalent.

The following three connections can be identified in FIG. 6a:

C1: {1, 0, −1, 0}//input 0 of block 251 is external input
C2: {2, 0, 1, 0}//input 0 of block 252 points to output 0 of block 251
C3: {−1, 0, 2, 0}//output 0 of block 252 is external output

Considering FIG. 6b the following connection can be added:

C4: {1, 1, 2, 0}//input 1 of block 251 points to output 0 of block 252

The connection map 207 may comprise a plurality of links (connections) between different filter blocks. The input of a specific filter block and the output of another filter block defines a link. The connection map also can contain one entry to define the external input and one entry to define the external output. For the metabolic measurement device the connection map is fixed and can be of the type: Response, Reduced and Advanced. The selection of the appropriate connection map is done automatically when constructing the filter models from the initialization file. The selection criteria will be discussed in the implementation chapter. A possible connection map for FIG. 6b could be the following:

Example Map={//input, output
C1: {1, 0, −1, 0}//input 0 of block 251 is external input
C2: {2, 0, 1, 0}//input 0 of block 252 points to output 0 of block 251
C3: {1, 1, 2, 0}//input 1 of block 251 points to output 0 of block 252
C4: {−1, 0, 2, 0}//output 0 of block 252 is external output};

The linear filter 209 represents a classical digital filter. The transfer function for a digital filter is defined by two polynomials: A_{M}=[1, a1, . . . , a_{M}] and B_{N}=[b0, b1, bN] such that the output of the filter is given by:

$${y}_{k} = {\sum }_{n = 0}^{N} {b}_{n} {x}_{k - n} - {\sum }_{n = 1}^{M} {a}_{n} {y}_{k - n}$$

wherein: xₙ=unfiltered samples of the input signal; and
yₙ=feedback of the filtered output samples

If both polynomials A_{M} and B_{N} are non-zero the filter has an Infinite Impulse Response (IIR). If A_{M} is zero the filter has a Finite Impulse Response (FIR). To initialize a linear filter from file first the number of coefficients must be declared. This is done with the number sign “#” followed by the number of coefficients that will follow. Each filter coefficient is then defined by an index and the accompanying An and Bn values. To define a FIR filter, it is recommended to ensure using “- - - ” declarations for the An entries, this will save memory when initializing the filters. All zero coefficients will be initialized from file but will be skipped during calculation. Below an example is given of the definition for a low pass FIR filter with output equation: yₖ=−0.0087 xₖ+0.2518 xₖ₋₂+0.5138 xₖ₋₃+0.2518 xₖ₋₄−0.0087 xₖ₋₆.

### [Example Filter]

#=5;

| index, | An, | Bn |
|---|---|---|
| n0= | 0, -------, | −0.00870, |
| n1= | 2, -------, | 0.25180, |
| n2= | 3, -------, | 0.51380, |
| n3= | 4, -------, | 0.25180, |
| n4= | 6, -------, | −0.00870, |

The step expert 211 may comprise a set of rules that is used to detect a step on its input data stream. A step needs to be pre-defined as a set of testable constriction on specified data properties. Each condition is converted into a rule by defining accept and discard routines. The step expert executes these rules to conclude if the incoming data can contain a step. A step expert has one input and one output. For the metabolic measurement device a step expert has a fixed set of rules that are determined by analyses of breath-by-breath data. FIG. 7 illustrates decision points for step detection. In defining step expert rules, the rules for the step expert are based on some important properties of the gas fractions during breath-by-breath measurement:
the fraction signal is a continuous signal (no discontinuous section);
the artifacts that can occur are well defined;
the properties of an up-step are identical to those of a down-step; and
the variations among different steps are limited.

For comparison reasons with the known metabolic measurement devices, a filter model was developed that establishes the existing response expert or existing response wizard. The existing response expert 213 may consist of a set of rules that is used to correct the response according to the algorithm in the existing metabolic measurement family of devices (response wizard). The algorithm needed to be defined in testable constriction on specified data properties. Each condition is converted into a rule by defining accept and discard routines. The existing response expert executes these rules to correct the incoming data to the required response. The existing response expert has one input and one output. For the metabolic measurement device the existing response expert has a fixed set of rules that are determined by analyses of the existing algorithm. Reference is made to FIG. 8, which is a graphical representation of an existing response correction wizard adapted for 10 ms data. In defining of existing response expert rules, the rules for the existing response expert are based on certain properties of the input step expert.

The gain expert 215 may comprise a set of rules that is used to calculate an appropriate gain for the incoming data streams. The gain calculation needs to be pre-defined as a set of testable constriction on specified data properties. Each condition is converted into a rule by defining accept and discard routines. The gain expert executes these rules to calculate the appropriate gain for the incoming data. The gain expert has four inputs and one output. For a metabolic measurement device a gain expert may have a fixed set of rules. In defining gain expert rules, the rules for the gain expert are based on properties of the first derivative of the inverse filtered response and a moving average response.

The filter pool 217 can contain the filter blocks that are used for the O₂ and CO₂ response correction. For a metabolic measurement device each filter pool may consist of fixed number of filter blocks that are listed below. The filter blocks are connected using predefined connection maps that can be of the type Regular Response Map, Reduced Map, and Advanced Map.

| ID | Name | Type |
|---|---|---|
| FilterBlock 0 | InputStepExpert | Step Expert |
| FilterBlock 1 | OutputStepExpert | Step Expert |
| FilterBlock 2 | CorrectionFilter | Linear Filter |
| FilterBlock 3 | RegularResponseExpert | Regular Response Expert |
| FilterBlock 4 | LowPassFilter | Linear Filter |
| FilterBlock 5 | MovingAverageFilter | Linear Filter |
| FilterBlock 6 | Delay3Filter | Linear Filter |
| FilterBlock 7 | Derivative4Filter | Linear Filter |
| FilterBlock 8 | LowPass5Filter | Linear Filter |
| FilterBlock 9 | Derivative6Filter | Linear Filter |
| FilterBlock 10 | LowPass7Filter | Linear Filter |
| FilterBlock 11 | Delay8Filter | Linear Filter |
| FilterBlock 12 | Delay9Filter | Linear Filter |
| FilterBlock 13 | GainExpert | Gain Expert |
| FilterBlock 14 | LowPass10Filter | Linear Filter |
| FilterBlock 15 | LowPassPreFilter | Linear Filter |

The existing response connection map 219 may consist of the connections to construct a filter model that imitates the response correction of the existing metabolic measurement devices. Connecting the filter blocks according to the existing response connection map results in the so-called “existing response filter model” as shown in FIG. 9. FIG. 9 shows the existing response connection map 301 with corresponding filter model 303 and the calculation order 305. The connecting map is represented by:

{0, 0, −1, 0}
{1, 0, 3, 0}
{2, 0, 0, 0}
{3, 0, 2, 0}
{−1, 0, 1, 0}.

The filter model includes an Input Step Expert (0) 307, a Correction Filter (2) 309, a existing Response Expert (3) 311, and an Output Step Expert (1) 313, arranged between an input 315 and an output 317. The calculation order 305 is: {0, 2, 3, 1}.

The reduced map 221 may comprise the connections to construct a filter model that replaces the existing response correction with a linear filter equivalent. Connection of the filter blocks according to the reduced map results in the so-called “reduced filter model” as shown in FIG. 10. FIG. 10 shows the reduced connection map 401 with corresponding filter model 403 and the calculation order 405. The reduced filter model includes a reduced connection map 401 represented as:

{0, 0, −1, 0}
{1, 0, 3, 0}
{2, 0, 0, 0}
{4, 0, 2, 0}
{−1, 0, 1, 0}.

The filter model 403 includes an Input Step Expert (0) 407, a Correction Filter (2) 409, a Low Pass Filter (4) 411, and an Output Step Expert (1) 413, between an input 415 and an output 417. The calculation order 405 being: {0, 2, 4, 1}.

The advanced map 223 may comprise the connections to construct a filter model that replaces the existing response correction with a non-linear equivalent.

Connecting the filter blocks according to the listed connections results in an advanced filter model 501 as shown in FIG. 11. FIG. 11 also shows the calculation order 503. The Advanced Filter Model 501 of FIG. 11 includes an Advanced Connection Map represented as:

{0, 0, −1, 0}
{1, 0, 14, 0}
{15, 0, 0, 0}
{2, 0, 15, 0}
{4, 0, 2, 0}
{5, 0, 4, 0}
{6, 0, 4, 0}
{7, 0, 5, 0}
{8, 0, 7, 0}
{9, 0, 6, 0}
{10, 0, 9, 0}
{11, 0, 5, 0}
{12, 0, 6, 0}
{13, 0, 11, 0}
{13, 1, 8, 0}
{13, 2, 10, 0}
{13, 3, 12, 0}
{14, 0, 13, 0}
{−1, 0, 1, 0}

The advanced filter model 501 has, starting from the input 505, an array of fast filters, including an Input Step Expert (0) 507, a Low Pass Pre Filter (15) 511, a Correction Filter (2) 513, and a first Low Pass Filter (4) 515. This array of fast filters is followed by a section of smoothing filters providing a branch for correction filtering 517 and a branch for moving average filtering 519, culminating in Gain Expert (13) 521. The correction filtering branch 517 is headed by a first Delay 3 Filter (6) 523, which branches into Derivative 6 Filter (9) 525 and a third Delay 9 Filter (12) 527. The second Derivative 6 Filter (9) 525 is followed by a third Low Pass 7 Filter (10) 529, which leads to the Gain Expert (13) 521. The third Delay 9 Filter (12) 527 connects directly to the Gain Expert (13) 521. The moving average filtering branch 519 starts at Moving Average Filter (5) 531, which branches into second Delay 8 Filter (11) 533 and Derivative 4 Filter (7) 535. The Derivative 4 Filter (7) 535 is followed by a second Low Pass 5 Filter (8) 537 and then connects to the Gain Expert (13) 521. The Delay 8 Filter (11) 533 leads directly to the Gain Expert (13) 521. The Gain Expert (13) 521 leads to the output 539 via a fourth Low Pass 10 Filter (14) 541 and the Output Step Expert (1) 509. The Calculation Order is represented by: {0, 15, 2, 4, 5, 7, 11, 8, 6, 12, 9, 10, 13, 14, 1}.

The filter blocks can be explained as follows:

### 507: Input Step Expert (0)

The input step expert analyses the input signal to determine the step size and onset times of the input signal. These values are necessary for the delay time determination and for the Gain expert.

### 511: Low Pass Pre Filter (15)

This filter attenuates higher frequencies of the input signal to avoid unpredicted behavior of the correction filter for these high frequencies.

### 513: Correction Filter (2)

This is the actual response correction filter (inverse filter 1/S). It is implemented as a FIR filter to guarantee stability and to obtain DC accuracy.

### 515: Low Pass Filter (4)

This filter attenuates higher frequencies which are introduced and/or amplified by the Correction Filter.

### 531: Moving Average Filter (5)

This filter attenuates the ringing frequencies which are introduced by the Correction Filter. The length of the moving average is adjusted to the frequencies of the ringing which are very typical for a specific Correction Filter.

### 523: Delay 3 Filter (6)

This is a delay which is equal to the delay of the Moving Average (MA) Filter. This delay is introduced to obtain exactly the same delay in signal MA signal path and the correction (CORR) signal path

### 535: Derivative 4 Filter (7)

The derivative of the MA signal is one of the inputs which control the Gain Expert.

### 537: Low Pass 5 Filter (8)

This filter attenuates higher frequencies in the derivative of the MA signal to prevent signal noise in this frequency band will disturb the Gain Expert.

### 525: Derivative 6 Filter (9)

The derivative of the CORR signal is one of the inputs which control the Gain Expert.

### 529: Low Pass 7 Filter (10)

This filter attenuates higher frequencies in the derivative of the CORR signal to prevent signal noise in this frequency band will disturb the Gain Expert.

### 533: Delay 8 Filter (11)

This is a delay which compensates for the delay of the Derivative 4 Filter and the Low Pass 5 Filter. This delay is introduced to obtain an equal delay in the MA signal path and the MA′ signal path.

### 527: Delay 9 Filter (12)

This is a delay which compensates for the delay of the Derivative 6 Filter and the Low Pass 7 Filter. This delay is introduced to obtain an equal delay in the CORR signal path and the CORR′ signal path.

### 521: Gain Expert (13)

The block mixes the CORR signal and the MA signal. The Gain Expert is controlled by the derivative of the CORR signal (CORR′) and the derivative of the MA signal (MA′). The thresholds used in the rules for the Gain Expert have to be applied at signals with an amplitude normalized to the step size as found in this signal. Step sizes are calculated by the Step Expert.

### 541: Low Pass 10 Filter (14)

This filter attenuates higher frequencies introduced by the mixing of the signals in the Gain Expert.

### 509: Output Step Expert (1)

The output step expert analyses the output signal to determine the onset times of the output signal which is necessary to qualify the filter behaviour.

While filter block 5, in this embodiment, is implemented as a moving average filter, it can be any filter type that is suitable to attenuate the ringing frequencies introduced by the correction filtering.

The Gain Expert (15) is subjected to the following rules:

If(Abs(ma′)>G1Threshold) AND (Abs(corr′)>G1Threshold) AND
(sign(ma′) != sign(corr′)) Then

Gain=Abs(ma′)/G1Factor

Else

If Abs(ma′)>G2Thesholdhigh Then

Gain = 1

Else

If Abs (ma′) < G2ThresholdLow Then

Gain = 0

Else

Gain = (Abs(ma′) − G2ThresholdLow)/(G2ThresholdHigh−

G2ThresholdLow)
//Note: not the derivatives but the real signals are mixed
Output = Gain*corr + (1−Gain)*ma
G1Threshold = 0.001
G1Factor = 0.05
G2Thesholdhigh = 0.03
G2ThresholdLow = 0.01

Hence, the Gain Expert (15) sets the relative gains of the MA signal and the CORR signal to be combined, on the basis of the (absolute) value of the first derivative of the MA signal and the (absolute) value of the first derivative of the CORR signal. The relative gains in this example are such that these are complementary for the MA signal and the CORR signal, i.e. the gain for the MA signal plus the gain for the CORR signal adds up to 100%.

More specifically, the Gain Expert (15) sets the relative gains of the MA signal and the CORR signal to be combined, on the basis of the (absolute) value of the first derivative of the MA signal and the (absolute) value of the first derivative of the CORR signal by comparing the derivative of the MA signal and the derivative of the CORR signal with a, here predetermined, first threshold value (G1Threshold).

In this example, the Gain Expert (15) is arranged to determine whether, in combination, the absolute value of the first derivative of the MA signal exceeds the first threshold value, the absolute value of the first derivative of the CORR signal exceeds the first threshold value and the sign of the derivative of the CORR signal is not equal to the sign of the derivative of the MA signal. In the affirmative, the Gain Expert calculates the relative gain on the basis of the absolute value of the first derivative of the MA signal. In the negative, the Gain Expert determines whether the absolute value of the first derivative of the MA signal exceeds a second, high, threshold value (G2Thresholdhigh). In the affirmative, the Gain Expert bases its output signal solely on the CORR signal. In the negative, the Gain Expert proceeds to determine, whether the absolute value of the first derivative of the MA signal is lower than a third, low, threshold value (G2Thresholdlow). In the affirmative, the Gain Expert bases its output signal solely on the MA signal. In the negative, the Gain Expert bases the relative gain on the relative position of the absolute value of the first derivative of the MA signal between the second and third threshold values.

The class response plus filters can contain the CO₂ and O₂ filter pools and the CO₂ and O₂ filter models. The filter models are constructed by connecting the filters from the pool corresponding to the active connection map.

Operation includes determination of a calculation order. An important issue to address is in which order the different filter blocks need to be calculated.

As an example reference is again made to the filter model that may consist of two filter blocks as shown in FIGS. 6a and 6b. In FIG. 6a it is clear that the output of filter block 1 needs to be calculated before the output of filter block 2 can be calculated. However when looking at FIG. 6b, it is seen that filter block 1 needs the output of filter block 2, but filter block 2 needs the output of filter block 1. To find that out which one goes first it is necessary to take into account the purpose of feedback loops. In control engineering a feedback loop, as in FIG. 6b, is mainly used to correct the error that is made in the open loop connection of the two filter blocks as depicted in FIG. 6a. From this point of view the feedback loop is only useful if it can contain data that is processed by both filter blocks. Therefore, also in FIG. 6b the calculation order is the same as in FIG. 6a. It might seem trivial to find the feedback loops, but that is only because the feedback loop is visibly represented. In practice the filter model only has a number of filter blocks and a number of connections. Therefore it must detect the feedback loops by somehow “walking” through the model. When the feedback loops are detected the calculation order will be known as well.

Such an algorithm starts by finding the filter block that receives the external input. This so-called root filter will be the first filter block to calculate. The algorithm continues by starting a backward search to find the filter blocks that are connected to the inputs of the root filter. When a filter block is detected and was not found before, the algorithm starts a new search for that new filter block. When the filter block was already found but not yet included in the filter order, then the detected filter block is the next filter block for the calculation order. This recursively backwards searching continues until no more undetected filter blocks can be found. Then the algorithm starts a forward search to find the filter blocks that are connected to the output of the root filter. Again, when a filter block is detected and was not found before the algorithm starts over for the detected filter block. When the filter block was already found the filter block were the forward search was started is added to the calculation order. FIG. 12 shows an example of a filter model and corresponding connection map to demonstrate the calculation order determination algorithm. Note that a connection is defined as C={Input Filter ID, Input Number, Output Filter ID, Output Number}. Filter block 6 is in the feedback loop and therefore needs to be calculated after block 2 and 3 are calculated. Furthermore, block 5 needs to be calculated before block 4. The filter blocks 1 to 6 are arranged between an external input and an external output as shown in FIG. 12. The connection map is as follows:

c1={1, 0, −1, 0},
c2={2, 1, 1, 0},
c3={3, 0, 2, 0},
c4={4, 0, 3, 0},
c5={5, 0, 1, 0},
c6={4, 1, 5, 0},
c7={6, 0, 3, 0},
c8={2, 0, 6, 0},
c9={−1, 0, 4, 0}.

First the algorithm finds the external input by scanning the third column for the −1. This results in connection c1. The corresponding root filter is filter block 1 and will be the first block in the calculation order. The algorithm starts the backward search for filter block 1 (=scanning the first column for a 1, the second column for a 0). No new block is found. The forward search is started (=scanning the third column for a 1, and the fourth column for a 0). This results in connection c2. The corresponding filter block is 2. Block 2 was not found before, so the algorithm starts recursively with block 2, and so on. In the section below the algorithm flow will be listed together with the points were the filter blocks are marked as being found, and the points were the filter blocks are added to the calculation order. The result of the calculation order is the most right column.

Part of the operation is an initialization from file for the advanced filter model and method, which will now be described. To be able to easily adapt the response correction to future findings it must be possible to initialize the corresponding filter model from a description file without having to recompile the driver code. Therefore, every filter block must have a textual description by which it can be constructed at runtime. For the advanced filter method the initialization file is show in an initialization file for the “Advanced” filter model:

### [O₂ Low Pass Prefilter]

#=5;

| index | An | Bn |
|---|---|---|
| n0 = 0 | ------- | −0.00870 |
| n1 = 2 | ------- | 0.25180 |
| n2 = 3 | ------- | 0.51380 |
| n3 = 4 | ------- | 0.25180 |
| n4 = 6 | ------- | −0.00870 |

### [CO₂ Low Pass Prefilter]

#=5;

| index | An | Bn |
|---|---|---|
| n0 = 0 | ------- | −0.00870 |
| n1 = 2 | ------- | 0.25180 |
| n2 = 3 | ------- | 0.51380 |
| n3 = 4 | ------- | 0.25180 |
| n4 = 6 | ------- | −0.00870 |

### [O₂ Correction Filter]

#=55;

| index | An | Bn |
|---|---|---|
| n0 = 0 | ------- | −0.1264525 |
| n1 = 2 | ------- | 0.6370175 |
| n2 = 4 | ------- | −0.4213825 |
| n3 = 6 | ------- | −1.2012025 |
| n4 = 8 | ------- | 0.4869075 |
| n5 = 10 | ------- | 1.6785775 |
| n6 = 12 | ------- | −0.0149225 |
| n7 = 14 | ------- | −1.4037025 |
| n8 = 16 | ------- | −0.4992725 |
| n9 = 18 | ------- | 0.5540375 |
| n10 = 20 | ------- | 0.4745575 |
| n11 = 22 | ------- | 0.6887975 |
| n12 = 24 | ------- | −0.1651525 |
| n13 = 26 | ------- | −1.4986925 |
| n14 = 28 | ------- | −0.7173825 |
| n15 = 30 | ------- | 1.2695275 |
| n16 = 32 | ------- | 1.5947575 |
| n17 = 34 | ------- | −0.0820725 |
| n18 = 36 | ------- | −1.4005825 |
| n19 = 38 | ------- | −1.1038325 |
| n20 = 40 | ------- | 0.4492575 |
| n21 = 42 | ------- | 1.3297375 |
| n22 = 44 | ------- | 1.1139475 |
| n23 = 46 | ------- | −0.5493225 |
| n24 = 48 | ------- | −2.1212025 |
| n25 = 50 | ------- | −1.2387925 |
| n26 = 52 | ------- | 0.9356175 |
| n27 = 54 | ------- | 1.4487475 |
| n28 = 56 | ------- | 0.7823875 |
| n29 = 58 | ------- | 0.0370175 |
| n30 = 60 | ------- | −0.3822725 |
| n31 = 62 | ------- | 0.4229175 |
| n32 = 64 | ------- | 2.0179475 |
| n33 = 66 | ------- | 1.1894375 |
| n34 = 68 | ------- | −2.1491625 |
| n35 = 70 | ------- | −3.4221825 |
| n36 = 72 | ------- | −1.2155425 |
| n37 = 74 | ------- | 2.1399075 |
| n38 = 76 | ------- | 3.3841875 |
| n39 = 78 | ------- | 1.3365375 |
| n40 = 80 | ------- | −1.4983125 |
| n41 = 82 | ------- | −3.0978225 |
| n42 = 84 | ------- | −1.0564925 |
| n43 = 86 | ------- | 1.5971675 |
| n44 = 88 | ------- | 1.8739875 |
| n45 = 90 | ------- | −0.1811025 |
| n46 = 92 | ------- | −0.8235525 |
| n47 = 94 | ------- | 0.2267375 |
| n48 = 96 | ------- | −0.1897825 |
| n49 = 98 | ------- | −0.9701925 |
| n50 = 100 | ------- | −0.0140425 |
| n51 = 102 | ------- | 1.4677175 |
| n52 = 104 | ------- | 0.2298775 |
| n53 = 106 | ------- | −1.0017125 |
| n54 = 108 | ------- | 0.1788275 |

### [CO₂ Correction Filter]

#=50;

| index | An | Bn |
|---|---|---|
| n0 = 50 | ------- | −0.46157 |
| n1 = 52 | ------- | 1.06996 |
| n2 = 54 | ------- | 0.25546 |
| n3 = 56 | ------- | −1.8137 |
| n4 = 58 | ------- | −0.96911 |
| n5 = 60 | ------- | 2.18945 |
| n6 = 62 | ------- | 2.86181 |
| n7 = 64 | ------- | 0.48295 |
| n8 = 66 | ------- | −1.85272 |
| n9 = 68 | ------- | −1.94704 |
| n10 = 70 | ------- | −0.0506 |
| n11 = 72 | ------- | 1.21858 |
| n12 = 74 | ------- | 0.8561 |
| n13 = 76 | ------- | −0.21971 |
| n14 = 78 | ------- | −0.72372 |
| n15 = 80 | ------- | −0.5015 |
| n16 = 82 | ------- | 0.23217 |
| n17 = 84 | ------- | 0.74978 |
| n18 = 86 | ------- | 0.51309 |
| n19 = 88 | ------- | −0.83322 |
| n20 = 90 | ------- | −0.90637 |
| n21 = 92 | ------- | 0.50949 |
| n22 = 94 | ------- | 0.95773 |
| n23 = 96 | ------- | −0.10884 |
| n24 = 98 | ------- | −0.56287 |
| n25 = 100 | ------- | −0.54412 |
| n26 = 102 | ------- | 0.31551 |
| n27 = 104 | ------- | 0.86368 |
| n28 = 106 | ------- | −0.16363 |
| n29 = 108 | ------- | −0.67109 |
| n30 = 110 | ------- | −0.17939 |
| n31 = 112 | ------- | 0.55721 |
| n32 = 114 | ------- | 0.25447 |
| n33 = 116 | ------- | −0.45554 |
| n34 = 118 | ------- | −0.13433 |
| n35 = 120 | ------- | 0.21397 |
| n36 = 122 | ------- | 0.23525 |
| n37 = 124 | ------- | −0.21143 |
| n38 = 126 | ------- | −0.20312 |
| n39 = 128 | ------- | 0.1722 |
| n40 = 130 | ------- | 0.283 |
| n41 = 132 | ------- | −0.26197 |
| n42 = 134 | ------- | −0.36939 |
| n43 = 136 | ------- | 0.29136 |
| n44 = 138 | ------- | 0.46666 |
| n45 = 140 | ------- | −0.30801 |
| n46 = 142 | ------- | −0.35599 |
| n47 = 144 | ------- | 0.16034 |
| n48 = 146 | ------- | 0.25874 |
| n49 = 148 | ------- | −0.15998 |

### [O₂ Low Pass Filter]

#=3;

| index | An | Bn |
|---|---|---|
| n0 = 0 | 1.00000 | 0.09874 |
| n1 = 1 | −0.82623 | 0.19749 |
| n2 = 2 | 0.22120 | 0.09874 |

### [CO₂ Low Pass Filter]

#=3;

| index | An | Bn |
|---|---|---|
| n0 = 0 | 1.00000 | 0.09874 |
| n1 = 1 | −0.82623 | 0.19749 |
| n2 = 2 | 0.22120 | 0.09874 |

### [O₂ Moving Average Filter]

#=13;

| index | An | Bn |
|---|---|---|
| n0 = 0 | ------- | 0.07692 |
| n1 = 1 | ------- | 0.07692 |
| n2 = 2 | ------- | 0.07692 |
| n3 = 3 | ------- | 0.07692 |
| n4 = 4 | ------- | 0.07692 |
| n5 = 5 | ------- | 0.07692 |
| n6 = 6 | ------- | 0.07696 |
| n7 = 7 | ------- | 0.07692 |
| n8 = 8 | ------- | 0.07692 |
| n9 = 9 | ------- | 0.07692 |
| n10 = 10 | ------- | 0.07692 |
| n11 = 11 | ------- | 0.07692 |
| n12 = 12 | ------- | 0.07692 |

### [CO₂ Moving Average Filter]

#=13;

| index | An | Bn |
|---|---|---|
| n0 = 0 | ------- | 0.07692 |
| n1 = 1 | ------- | 0.07692 |
| n2 = 2 | ------- | 0.07692 |
| n3 = 3 | ------- | 0.07692 |
| n4 = 4 | ------- | 0.07692 |
| n5 = 5 | ------- | 0.07692 |
| n6 = 6 | ------- | 0.07696 |
| n7 = 7 | ------- | 0.07692 |
| n8 = 8 | ------- | 0.07692 |
| n9 = 9 | ------- | 0.07692 |
| n10 = 10 | ------- | 0.07692 |
| n11 = 11 | ------- | 0.07692 |
| n12 = 12 | ------- | 0.07692 |

### [O₂ Delay 3 Filter]

#=1;

| index | An | Bn |
|---|---|---|
| n0 = 6 | ------- | 1.00000 |

### [CO₂ Delay 3 Filter]

| index | An | Bn |
|---|---|---|
| n0 = 6 | ------- | 1.00000 |

### [Simple Delay]

#=1;

| index | An | Bn |
|---|---|---|
| n0 = 1 | ------- | 1.00000 |

### [Simple Derivator]

#=2;

| index | An | Bn |
|---|---|---|
| n0 = 0 | ------- | 1.00000 |
| n1 = 1 | ------- | −1.00000 |

### [Simple Low Pass]

#=2;

| index | An | Bn |
|---|---|---|
| n0 = 0 | 1.00000 | 0.75000 |
| n1 = 1 | −0.25000 | 0.00000 |

The operation also includes connecting of filter blocks. As pointed out above the filter models are defined as a number of filter blocks with a specific set of connections. Calculating the output of the resulting model can be done in several ways.

One is to calculate the output of the first filter block as determined by the calculation order, pass it on to the next filter block of the calculation order, calculate it and so on until all filter blocks are calculated. However, this way of calculating requires a lot of overhead in transferring data from filter blocks to the filter model and visa versa. Once a model is constructed the connection are pretty much fixed for the lifetime of the model. Therefore, a much more efficient way of calculating the output of a filter model would be to let each filter block get its own input without interference of the model. To make that possible the inputs of each filter bock must be connected with an output of another filter block.

It is thus believed that the operation and implementation of the present invention will be apparent from the foregoing description. The invention is not limited to any embodiment herein described and, within the purview of the skilled person, modifications are possible which should be considered within the scope of the appended claims. Equally all kinematic inversions are considered inherently disclosed and to be within the scope of the present invention. The term comprising when used in this description or the appended claims should not be construed in an exclusive or exhaustive sense but rather in an inclusive sense. Expressions such as: “means for . . . ” should be read as: “component configured for . . . ” or “member constructed to . . . ” and should be construed to include equivalents for the structures disclosed. The use of expressions like: “critical”, “preferred”, “especially preferred” etc. is not intended to limit the invention. Features which are not specifically or explicitly described or claimed may be additionally included in the structure according to the present invention without deviating from its scope.

1. A system for analyzing a fluctuating flow of a mixture of gases having an optionally variable frequency to determine a momentary presence and/or quantity of at least one selected gaseous component in the fluctuating flow, including at least one electronic sensor adapted to generate a measurement signal representative of at least one of the presence and quantity of the at least one gaseous component and having a response rate slower than the frequency of the fluctuating flow, wherein a processing unit is arranged for subjecting the measurement signal to a correction to construct a momentary corrected signal that equals, or at least closely resembles, at least one of the momentary presence and quantity of the at least one gaseous component, wherein the correction includes inverse filtering and moving average filtering, and wherein the processing unit includes a gain expert filter employing an algorithm blending an inverse filtered correction response signal and a moving averaged response signal by applying a set of rules.

2. A system according to claim 1, wherein the gain expert filter is adapted to set relative gains of the moving average signal and correction signal to be combined, on basis of a derivative of the moving average signal and a derivative of the correction signal.

3. A system according to claim 2, wherein the gain expert filter sets the relative gains of the moving average signal and the correction signal to be combined, on basis of an absolute value of a first derivative of the moving average signal and an absolute value of a first derivative of the correction signal by comparing the derivative of the moving average signal and the derivative of the correction signal with a predetermined, first threshold value.

4. A system according to claim 1, including a relatively fast inverse filtering stage and a smoothing filtering stage, which incorporates the gain expert filter.

5. A system according to claim 4, wherein the inverse filtering stage precedes the smoothing filtering stage.

6. A system according to claim 4, wherein the smoothing stage is provided with a branch for correction filtering and a branch for moving average filtering.

7. A system according to claim 6, wherein the smoothing stage further includes a gain expert filter block, joining the branches for correction filtering and moving average filtering into a common output.

8. A system according to claim 7, wherein the gain expert filter block is controlled by a derivative of the correction signal and a derivative of the moving average signal.

9. A system according to claim 7, wherein rules for the gain expert filter block use thresholds that are applied at signals with amplitude normalized to a step size as found in these signals.

10. A system according to claim 9, wherein the step sizes are calculated by a step expert subroutine.

11. A system according to claim 10, wherein the gain expert filter block is adapted to employ rules that include comparison of the moving average signal and the correction signal with a predetermined threshold to determine a gain value.

12. A system according to claim 4, wherein the smoothing stage includes a filter block that is adapted to attenuate ringing frequencies introduced by the inverse filtering.

13. A system according to claim 12, wherein the filter block adapted to attenuate the ringing frequencies is a moving average filter.

14. A system according to claim 13, wherein a length of the moving average is adjusted to frequencies of the ringing which are typical for a specific inverse correction filter.

15. A system according to claim 13, wherein the smoothing stage further includes a delay filter block that has a delay equal to a delay of the moving average filter block.

16. A system according to claim 13, further including a first filter block for determining a derivative.

17. A system according to claim 16, wherein the first filter block for determining a derivative is positioned between an output of the moving average filter block and an input of the gain expert filter block to control the gain expert filter block.

18. A system according to claim 17, wherein a second low pass filter block is additionally included between an output of the first filter block for determining a derivative and an input of the gain expert filter block.

19. A system according to claim 15, further including a second filter block for determining a derivative for providing a derivative of the correction signal as an input for controlling the gain expert filter block.

20. A system according to claim 19, further including a third low pass filter block between an output of the second filter block for determining a derivative and an input of the gain expert filter block.

21. A system according to claim 13, further including a second delay filter block between an output of the moving average filter block and an input of the gain expert filter block, to compensate for signal delay of the first filter block for determining a derivative and the second low pass filter block.

22. A system according to claim 15, further including a third delay filter block, between an output of the first delay filter block and an input of the gain expert filter block, to compensate for delay of the second filter block for determining a derivative and the third low pass filter block.

23. A system according to claim 1, further including an input step expert filter for analyzing the input signal to determine a step size and onset times of the input signal.

24. A system according to claim 23, further including an inverse response correction filter block.

25. A system according to claim 24, wherein the inverse response correction filter block is a finite impulse response filter.

26. A system according to claim 1, further including an output step expert filter block to analyze an output signal to determine onset times of the output signal.

27. A system according to claim 1, wherein connections are defined linking outputs and inputs of filter blocks in accordance with a connection map, which is generated from an initialization file.

28. A system according to claim 1, including a flow meter, a gas flow analyzing device and a processing unit.

29. A method of analyzing a fluctuating flow of a mixture of gases having an optionally variable frequency to determine at least one of a presence and quantity of at least one selected gaseous component in the fluctuating flow, using at least one electronic sensor adapted to generate a measurement signal representative of at least one of the presence and quantity of the at least one gaseous component and having a response rate slower than the frequency of the fluctuating flow, wherein the measurement signal is subjected to a correction to construct a momentary corrected signal that equals, or at least closely resembles, at least one of the momentary presence and quantity of the at least one gaseous component, and wherein the correction includes inverse filtering and moving average filtering and an algorithm blending an inverse filtered correction response signal and a moving average response signal by applying a set of rules.

30. A method of claim 29, wherein the algorithm is employed by a gain expert filter, which sets relative gains of the moving average response signal and the correction response signal to be combined, on basis of a derivative of the moving average signal and a derivative of the correction signal.

31. A method of claim 30, wherein the relative gains are complementary for the moving average signal and the correction signal, adding up to 100%.

32. A method of claim 30, wherein, the gain expert filter sets the relative gains of the moving average signal and the correction signal to be combined, on the basis of an absolute value of a first derivative of the moving average signal and the absolute value of the first derivative of the correction signal by comparing an derivative of a moving signal and the derivative of the correction signal with a predetermined, first threshold value.

33. A method according to claim 29, wherein the fluctuating flow is proportionally sampled.

34. A system for analyzing a fluctuating flow of a mixture of gases having an optionally variable frequency to determine a presence and/or quantity of at least one selected gaseous component in the fluctuating flow, including at least one electronic sensor adapted to generate a measurement signal representative of at least one of the presence and quantity of the at least one gaseous component and having a response rate significantly slower than the frequency of the fluctuating flow, wherein a gas sample is extracted by a proportional pump via a relatively small mixing chamber, wherein the proportional pump is controlled by signals from a flow sensor, to adapt the flow through the pump in proportion to the gas flow measured by the flow sensor.
